(19) United States
(12) Patent Application Publication
(10) Pub. No.: US 2026/0021862 A1
(43) Pub. Date: Jan. 22, 2026

(54) Foldable Cargo Trike with Anti-Tip Braking System and Alternative Drive Configurations

(71) Applicant: Damir Gilyaz, Rego Park, NY (US)

(72) Inventor: Damir Gilyaz, Rego Park, NY (US)

(21) Appl. No.: 19/212,311

(22) Filed: May 19, 2025

Related U.S. Application Data
(60) Provisional application No. 63/673,317, filed on Jul. 19, 2024.

(51) Int. Cl. B62K 5/027; B60K 1/02; B60K 1/04; B60K 17/04; B60K 17/12; B60K 17/16; B60K 23/04; B60K 28/02; B60K 28/14; B62J 45/20; B62K 5/06; B62K 7/04; B62K 15/00; B62L 5/00; B62L 5/18

(52) U.S. Cl. CPC B62K 5/027; B60K 1/02; B60K 1/04; B60K 17/046; B60K 17/12; B60K 17/16; B60K 23/04; B60K 28/02; B60K 28/14; B62J 45/20; B62K 5/06; B62K 7/04; B62K 15/008; B62L 5/006; B62L 5/18; B60K 2001/0416; B60K 2023/043

(57) ABSTRACT

A foldable cargo trike equipped with at least four drive train configurations and an advanced stability control system (herein referred to as the 'trike) is disclosed. A first embodiment features a frame-mounted drive motor with a mechanical differential for the rear two wheels. A second embodiment utilizes an electronic differential with dual, independently-controlled hub motors on each rear wheel. In this embodiment, each drive motor is dynamically-adjusted by artificial intelligence algorithms. These algorithms analyze user driving habits and enable the trike to adapt in real-time for improved performance and safety. These first two embodiments have an anti-tip braking system controlled by two front-mounted sensors to detect lateral tilt or roll conditions and automatically applying braking to prevent tipping. A third embodiment includes two, frame-mounted electric motors connected to each wheel. A fourth embodiment includes a frame-mounted, electric drive motor having a planetary gear set which mimics a conventional differential.

### CROSS-REFERENCE TO RELATED APPLICATIONS

The present application includes subject matter disclosed in and claims priority to a provisional application U.S. Pat. No. 63,673,317 filed on Jul. 19, 2024 describing an invention made by the present inventor.

### FIELD OF THE INVENTION

The present invention generally relates to tricycles. More specifically, it relates to a tricycle with mechanical and electrical differentials with onboard software controls.

### BACKGROUND

Three-wheeled cargo tricycles are widely used in urban environments worldwide, particularly in developing nations, where they serve as a primary means of transporting goods and conducting small-scale commercial deliveries. These vehicles are favored for their affordability, ease of maintenance, and ability to navigate congested city streets. However, despite their widespread use, conventional cargo trikes suffer from significant stability challenges, particularly when navigating turns or operating with unbalanced loads. The absence of effective differential systems in these vehicles is a critical limitation, directly affecting their safety and performance. Traditional trikes are often designed with rigid rear axles, which lack any form of differential. This design forces both rear wheels to rotate at the same speed, regardless of the vehicle's turning radius. When turning, the inside wheel travels a shorter path than the outside wheel, but because of the rigid connection, both wheels attempt to maintain the same speed. This mismatch leads to tire skidding, loss of traction, and increased risk of tipping, particularly on uneven surfaces or at higher speeds. These issues are further exacerbated in cargo trikes, where the added weight of goods amplifies the instability. Existing solutions, such as adding weight to lower the center of gravity or using wide, low-pressure tires to increase grip, only partially address these stability concerns and often introduce new problems, such as increased rolling resistance or reduced maneuverability. More advanced solutions, such as electronic stability control systems, are generally too complex and costly for mass deployment in developing regions, where most trikes are manually operated or rely on basic motorization. Furthermore, even in cases where motorized trikes are used, the absence of adaptive drivetrain control prevents these vehicles from maintaining optimal traction during variable operating conditions. Drivers in densely populated cities face frequent and unpredictable changes in road surfaces, inclines, and pedestrian traffic, making precise control critical. The lack of a practical differential or adaptive control system not only compromises safety but also reduces operational efficiency, as drivers are forced to slow down significantly in turns to avoid tipping. The present invention addresses these challenges by providing a foldable cargo trike with at least four distinct, interchangeable differential embodiments. A first embodiment features a single drive motor with a conventional, mechanical differential for the rear two wheels. A second embodiment utilizes an electronic differential with two, independently-controlled motors on each rear wheel. In this embodiment, each drive motor is dynamically-adjusted by artificial intelligence algorithms. These algorithms analyze user driving habits and enable the trike to adapt in real-time for improved performance and safety. A third embodiment includes two electric motors centrally-mounted in the frame connected to each wheel and a fourth embodiment includes a single, frame-mounted, electric drive motor connected to a planetary gear set which mimics a conventional differential.

### SUMMARY OF THE INVENTION

The device herein disclosed and described provides a solution to the shortcomings in the prior art through the disclosure of a foldable cargo trike equipped with four, distinct, interchangeable drivetrain embodiments with mechanical and electrical stability control systems. An object of the foldable cargo trike is to improve stability during turning maneuvers. This is achieved by integrating a differential system that adapts to varying wheel speeds when the vehicle turns. By allowing each rear wheel to rotate at a different speed, the trike can navigate corners more smoothly and safely, reducing the risk of tipping.

Another object of the invention is to provide a modular drivetrain system that can accommodate different propulsion methods. The foldable cargo trike can be configured with either a mechanical differential or an electronic differential system as the first two embodiments of the invention. The mechanical differential utilizes a centralized drive axle that evenly distributes power to both rear wheels, maintaining stability during operation. The electronic differential, on the other hand, consists of dual independently controlled hub motors that adjust torque dynamically, allowing for smoother handling and greater adaptability to driving conditions. A third embodiment includes two electric motors centrally-mounted in the frame connected to each wheel. A fourth embodiment includes a single, frame-mounted, electric drive motor with a planetary gear set which mimics a conventional differential.

Another object of the invention is to enhance user safety through a sensor-based anti-tip braking system. This system includes front-mounted sensors that detect lateral tilt or roll, triggering side-specific braking to counteract potential tipping events. This active stabilization system helps maintain balance, particularly during sharp turns or when the trike is loaded with cargo, thereby reducing accidents.

Another object of the invention is to adapt the trike's performance to individual user profiles through artificial intelligence. By incorporating onboard AI algorithms, the trike learns from the user's driving habits and adjusts torque distribution and braking sensitivity accordingly. For instance, a rider who frequently takes sharp turns at speed will benefit from tighter differential responses, while a more cautious rider will experience softer adjustments for comfort. This customization enhances both safety and rider experience.

Another object of the invention is to provide a platform for long-term data tracking and user customization. The trike utilizes a local blockchain system to log individual driving patterns and maintain a secure record of operational data. This information can be accessed through a mobile application, allowing users to analyze their driving trends, share data with other users, and customize differential and braking settings. This data-driven approach not only fosters user engagement but also facilitates predictive maintenance and performance optimization.

Another object of the invention is to facilitate easy customization and adjustment through a connected mobile application. The app allows users to create and store ride profiles, configure differential behavior, and adjust braking sensitivity based on personal preference or cargo load. This feature promotes a tailored riding experience and enables users to optimize the trike's handling for various environments.

Another object of the invention is to provide a foldable structure that enhances the portability and storage of the cargo trike. The frame includes a hinged mainframe that allows vertical or lateral folding, reducing the trike's footprint when not in use. A locking mechanism ensures that the trike remains securely folded during transport or storage, while mounting interfaces facilitate quick attachment of cargo racks and braking systems. This design is particularly advantageous for urban settings where space is limited.

Another object of the invention is to support versatile usage scenarios by enabling easy interchangeability between mechanical and electronic drivetrain configurations. The modular frame design accommodates all four embodiments without requiring significant structural modifications, allowing users to select a drivetrain based on specific performance needs or available components. This flexibility makes the trike suitable for a wide range of applications, from manual-powered models to electric-assisted versions.

Another object of the invention is to promote safer urban transportation in developing nations, where cargo trikes are commonly used for last-mile delivery. By addressing the critical stability issues associated with conventional trikes, this invention helps reduce accidents and improves operational efficiency. The dual drivetrain configuration also makes the trike adaptable to various urban environments and road conditions, particularly in densely populated areas where maneuverability and stability are essential.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a side view of the trike.

FIG. 2 shows a perspective view of the trike.

FIG. 3 shows a perspective closeup view of the front of the trike.

FIG. 4 shows a perspective closeup view of the seat system of the trike.

FIG. 5 shows a side view of the trike folded.

FIG. 6 shows a perspective closeup view of the electric differential embodiment.

FIG. 7 shows a perspective closeup view of the mechanical differential embodiment.

FIG. 7 shows a representative view of the invention's method.

Other aspects of the present invention shall be more readily understood when considered in
conjunction with the accompanying drawings, and the following detailed description, neither of which should be considered limiting.

### DETAILED DESCRIPTION OF FIGURES

In this description, terms such as up, upward, down, downward, front, back, top, upper, bottom, lower, left, right, and similar directional references pertain to the orientation of the device as shown in the accompanying drawings. These terms are provided for ease of understanding and are not meant to restrict or dictate the device's specific orientation or method of use. Additionally, standard components of the invention, which are already well-established in the prior art, will not be described in detail within this disclosure.

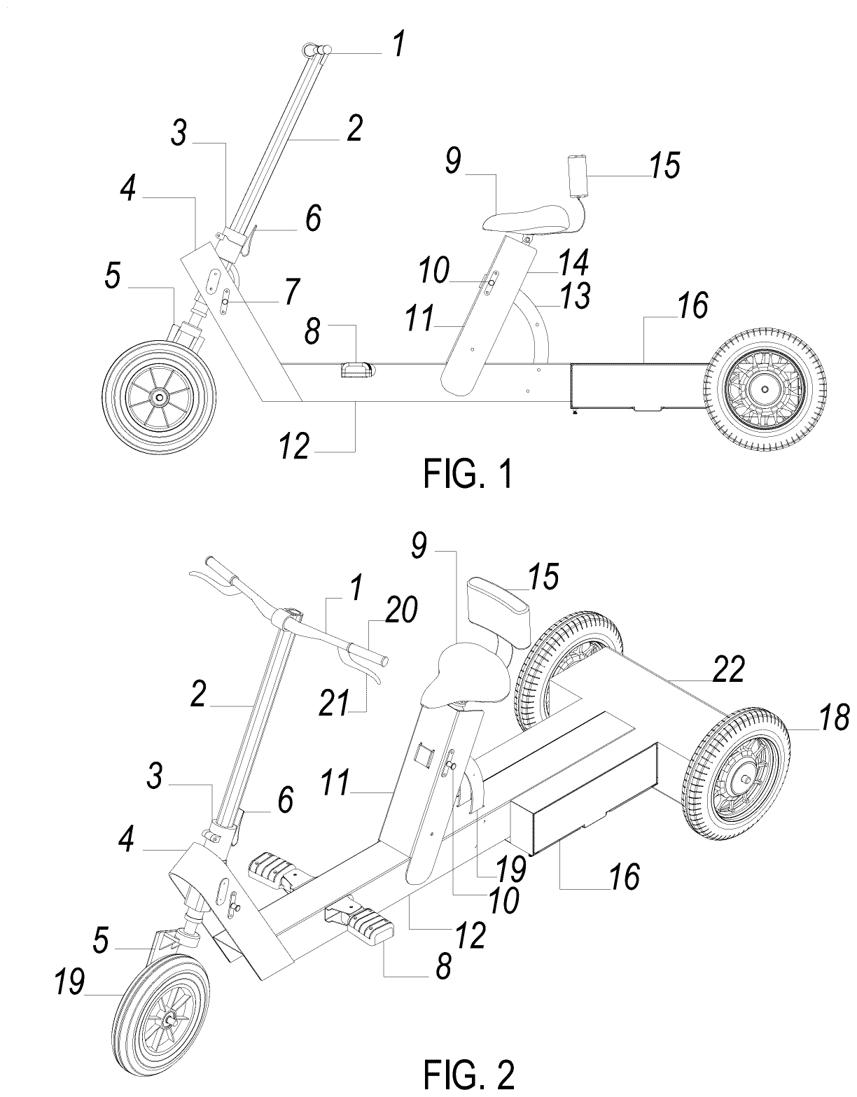

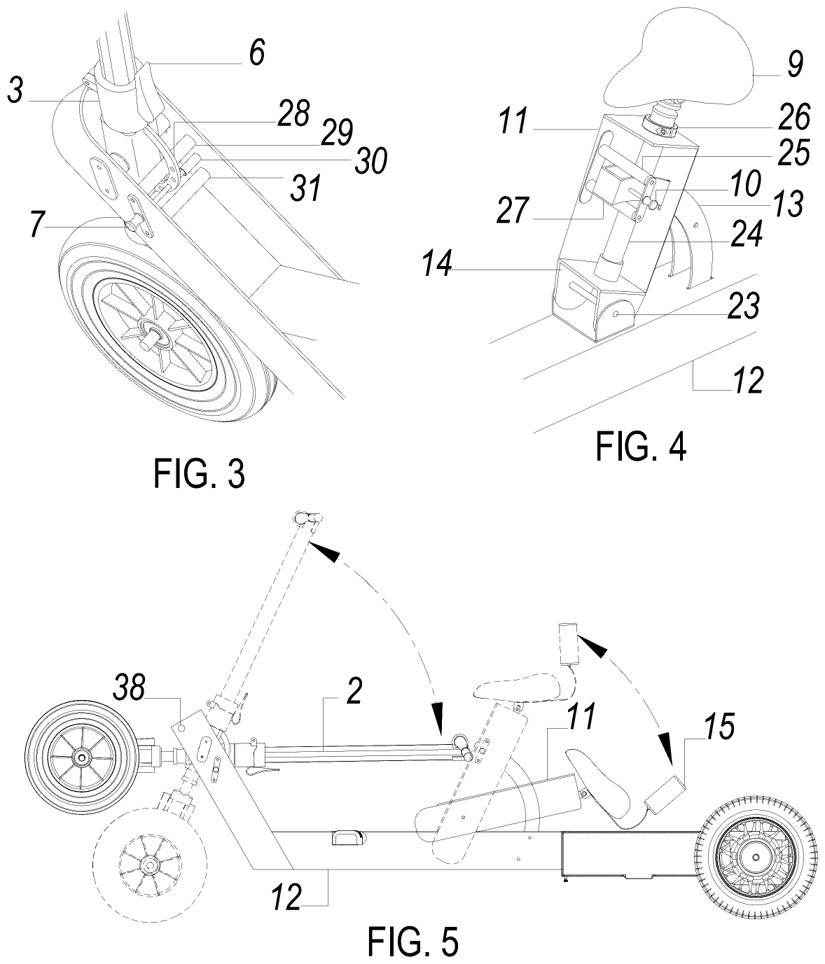

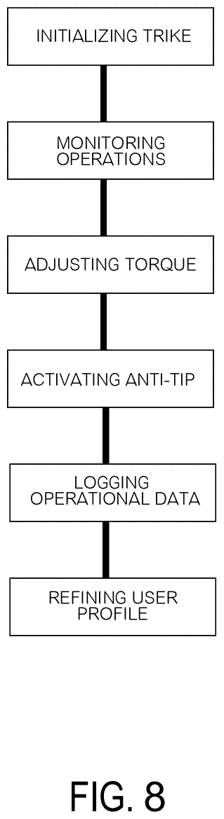

FIGS. 1 and 2 show various perspective views of an embodiment of the trike comprised of a conventional tricycle with at least, but not limited to three traditional wheels (front wheel 19 and rear wheels 18) with main frame 12 having foot pegs 8, connected to front frame 4, and rear cargo frame 22. The trike having standard seating (seat pan 9 and seat back 15) and being pivotably connected to frame 12 by seat stem cover 11. Handle bars 1 having manual braking 21 and grips 20 and are connected to stem 2 and stem collar 3. Said stem 3 being telescopically affixed by means of cam lever 6 on stem collar 3 and connected to front wheel 19 by means of wheel adapter 5 therebetween. The trike being powered by at least but not limited to two batteries 32 housed inside battery cover 16. This innovative vehicle is designed to enhance safety, versatility, and user customization for cargo transport in urban environments, including densely populated cities in developing nations where cargo trikes serve as essential last-mile delivery vehicles. The trike's frame 12 is constructed from, but not limited to, a durable, lightweight material, such as tubular aluminum alloy or reinforced steel, etc. and designed with a hinged front and seat areas that allows the vehicle to fold into a compact volume. These folding mechanisms are secured by finger-locking mechanisms, which ensures that the trike remains rigid during operation and securely compact when folded for storage. FIG. 3 showing how the handlebar assembly is supported at its base externally by means of axle plate 28 and internally by adjustment blade 28 being selectively connected to adjustment knob 7 and its pivoting travel being limited by upper rod 29 and lower rod 31. A user can unlock the handle bar assembly by pulling on said adjustment knob 7 which disengages adjustment rod 30 allowing said assembly to pivot. Similarly, the seating system includes seat pan 9 that is connected to frame 12 by means of seat stem 24 engaging pivot collar 14 that also allows it to be folded to a compact form. This folding is achieved by a system comprising a rear adjustment knob 10 engaging adjustment blade 13. The rear adjustment knob is pulled to disengage adjustment blade 13 allowing the seat to pivot on pivot rod 23. Travel of the seating being limited by upper rod 25 and lower rod 27. The seat stem is enclosed in seat housing 11. FIG. 5 showing how both the handle bar system and seating system are folded down onto frame 12. The modular frame 12 includes various mounting interfaces that accommodate cargo racks, electrical or hydraulic braking systems, and the drivetrain assemblies, allowing users to easily switch between two drivetrain configurations: a mechanical differential or an electronic differential with dual rear hub motors as depicted in FIG. 7. The first drivetrain embodiment employs a mechanical differential 36 driving axles 37 to rear wheels 18. In this configuration, a centralized drive axle is connected to differential gear assembly 36, which evenly distributes power to the two rear wheels 18. This configuration is ideal for users seeking a robust, mechanically simple solution that can be manually powered or driven by a single motor. The differential ensures that the rear wheels 18 can rotate at different speeds during turns, significantly improving stability and maneuverability compared to conventional rigid-axle designs. Brake calipers are mounted on each rear wheel, and when a tilt or roll condition is detected by the sensor system, the anti-tip braking system selectively applies braking force to one side to counteract the tipping force.

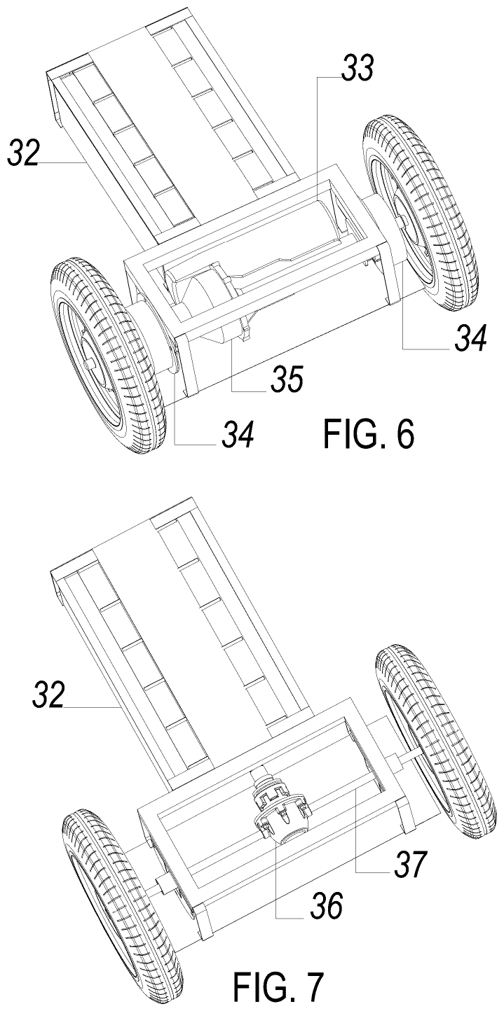

The second drivetrain embodiment is illustrated in FIG. 6 utilizes an electronic differential 35 with dual independently controlled rear hub motors 34. Both differential embodiments are powered by an electric battery pack 32-including but not limited to lead acid or lithium ion and the like-mounted within the frame 12. On the electronic differential embodiment, a central motor controller 35 regulates the torque output to each wheel 18. Unlike the mechanical differential 36, this electronic configuration leverages advanced software algorithms on a non-transitory medium to simulate differential behavior. The motor controller 35 continuously adjusts the torque delivered to each motor based on user inputs, road conditions, and vehicle orientation. The system also supports regenerative braking, which harnesses kinetic energy during deceleration to recharge battery 32. The anti-tip braking system is a key feature of the trike, providing enhanced safety in both drivetrain configurations and is governed by said algorithms on a transitory medium. This system is managed by two front-mounted tilt sensors 38, which may be configured as gyroscopes, inertial measurement units (IMUs), or other tilt detection devices. These sensors 38 continuously monitor the trike's lateral tilt and roll angles. When the sensors detect a tilt angle exceeding a predefined safety threshold, the system triggers side-specific braking. For the mechanical differential embodiment, this means activating a brake caliper on the rear wheel opposite the direction of tilt. In the electronic differential embodiment, the system reduces motor torque or applies regenerative braking on the tilting side to counteract the tipping force.

As mentioned, the trike is equipped with an onboard computer or microcontroller etc. having artificial an intelligence (AI) system designed to enhance ride safety and performance through adaptive learning. The AI algorithms monitor user driving habits, including speed, turning patterns, braking intensity, and cargo load. Over time, the AI system generates personalized riding profiles for each user, allowing the trike to automatically adjust differential settings, torque distribution, and braking sensitivity based on user preferences and driving habits. For instance, a user who frequently rides aggressively, making sharp turns at high speeds, will experience a tighter differential response, with quicker adjustments in torque distribution and more immediate braking action when a tilt is detected. In contrast, a user with a more cautious driving style will benefit from a softer, more gradual response, ensuring a smoother and more comfortable ride. These personalized profiles can be manually adjusted or overridden through a connected mobile application, which allows users to configure their differential and braking settings directly.

The mobile application serves as a user interface for the trike's advanced control systems. Users can view their riding history, adjust ride parameters, create custom ride profiles, and even share their data with other users. The app also supports wireless connectivity, enabling the trike to communicate with smartphones or other connected devices. This connectivity allows for remote updates to the trike's software, including the AI algorithms, ensuring that the trike can continuously improve its performance. The method is initiated when a user logs into the trike, either directly through the onboard display or via the mobile application. The AI system accesses the user's riding history, including data stored on the blockchain, to establish a user profile. During operation, the sensors continuously monitor steering angle, tilt, speed, and acceleration. These inputs are processed in real-time, and the AI system dynamically adjusts torque distribution between the rear wheels, brake sensitivity, and differential behavior. When a user completes a ride, the system logs the ride data to the blockchain, ensuring a secure, unalterable record of riding patterns. Over time, this data allows the AI to further refine the user's profile, enhancing safety and customization. This advanced integration of mechanical and electronic control systems, user-customized AI profiles, blockchain-based data security, and modular design establishes a new standard for foldable cargo trikes. It provides a highly adaptable solution for urban cargo transport, offering improved safety, efficiency, and user engagement.

Methods of operation include the following steps in more detail: Step One: Initialization. The user begins by logging into the trike, either directly through the onboard display or via the connected mobile application. The AI system accesses the user's riding history, including data stored on the blockchain, to establish a user profile. Step Two: Real-Time Monitoring. During operation, the trike's sensors continuously monitor key parameters, including steering angle, tilt, speed, acceleration, wheel rotation speeds, and motor output. These inputs are processed in real-time by the onboard control system, with each data point being compared against the user's established profile for adaptive adjustments. Step Three: Adaptive Adjustment. The AI system dynamically adjusts torque distribution between the rear wheels, brake sensitivity, and differential behavior based on the detected conditions and user profile. For the electronic differential embodiment, the AI can increase or decrease torque on each hub motor independently. For the mechanical differential, the AI can modulate braking force applied to each wheel to mimic torque control. Step Four: Anti-Tip Response. If a tilt or roll condition is detected by the sensors, the system automatically engages side-specific braking or torque reduction. In the mechanical differential embodiment, braking is applied to the wheel opposite the tilt. In the electronic differential embodiment, torque is reduced or reversed on the tilting side, and regenerative braking can be applied to enhance stability. Step Five: Data Logging. Upon completion of the ride, all operational data is securely logged onto the onboard blockchain. This ensures a secure, unalterable record of user driving patterns, including turn speeds, braking intensity, and response to tilt events. Step Six: Profile Refinement. Over time, the AI system analyzes a user's riding style, refining user profiles and further personalizing the ride experience. This allows the system to predict user behaviors and preemptively adjust settings for safety and performance. Profiles can be transferred between trikes or restored in case of system reset, ensuring continuity of user customization.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A foldable cargo trike, comprising:
a) a modular frame configured to allow folding for storage or transport;
b) a steering assembly including handlebars, a front wheel, and manual braking controls;
c) a first embodiment featuring a frame-mounted drive motor with a conventional, mechanical differential for the rear two wheels;
d) a second embodiment utilizing an electronic differential with dual, independently-controlled hub motors on each rear wheel wherein each drive motor is dynamically-adjusted by artificial intelligence algorithms;
e) a third embodiment includes two electric motors centrally-mounted in the frame connected to each wheel;
f) a fourth embodiment includes a single, frame-mounted, electric drive motor with a planetary gear set which mimics a conventional differential.
d) an anti-tip braking system, comprising two front-mounted sensors configured to detect lateral tilt or roll conditions, wherein the system applies side-specific braking to maintain stability;
e) an onboard computer system configured with artificial intelligence algorithms, wherein the algorithms monitor user driving habits and adjust differential behavior based on a user profile and is accessible through a connected mobile application; and
f) a mobile application that allows users to view riding history, adjust differential and braking settings, and create custom ride profiles.

2. A method of operating a foldable cargo trike, comprising the steps of:
a) Initializing the trike by logging into the system via an onboard display or connected mobile application, wherein the artificial intelligence system accesses user riding history stored on a local blockchain;
b) Monitoring key operational parameters during use, including steering angle, tilt, speed, acceleration, wheel rotation speeds, and motor output, using onboard sensors;
c) Dynamically adjusting torque distribution between the rear wheels, brake sensitivity, and differential behavior based on user driving habits, wherein for the electronic differential embodiment, the system adjusts torque of each rear hub motor independently, wherein for the mechanical differential embodiment, the system modulates braking force to simulate torque control;
d) Activating an anti-tip braking system when tilt or roll is detected, wherein the system applies side-specific braking or torque reduction to maintain stability;
e) Logging operational data upon completion of the ride, ensuring a secure and tamper-proof record of user driving patterns; and
f) Refining the user profile over time based on logged data, further personalizing torque distribution and braking sensitivity.

3. The foldable cargo trike of claim 1, wherein the modular frame further comprises:
a) a hinged mainframe allowing the handle bar system and seating system to fold; and
b) locking mechanisms ensuring secure folding during transport or storage.

4. The foldable cargo trike of claim 1, wherein the anti-tip braking system utilizes gyroscopes or inertial measurement units as the front-mounted sensors.

5. The foldable cargo trike of claim 1, wherein the electronic differential further supports regenerative braking, harnessing kinetic energy to recharge the battery pack.

6. The foldable cargo trike of claim 1, wherein the mobile application further enables wireless connectivity for remote updates to the artificial intelligence algorithms.

7. The method of claim 2, wherein the step of dynamically adjusting torque distribution further comprises analyzing user driving patterns in real-time and applying predictive adjustments based on historical data.

8. The method of claim 2, wherein the anti-tip braking system further comprises automatically calibrating tilt thresholds based on user behavior patterns.
